(19) United States
(12) Patent Application Publication
(10) Pub. No.: US 2023/0408105 A1
(43) Pub. Date: Dec. 21, 2023

(54) Method for Cleaning and Regeneration of Catalyst Within an Oven Cleaning System

(71) Applicant: Alto-Shaam, Inc., Menomonee Falls, WI (US)

(72) Inventors: Joshua J. Shimel, Waukesha, WI (US); Jon Paul Flick, Wales, WI (US); Craig Douglas Burnett, Slinger, WI (US)

(21) Appl. No.: 18/196,237

(22) Filed: May 11, 2023

Related U.S. Application Data
(60) Provisional application No. 63/342,697, filed on May 17, 2022.

(51) Int. Cl. F24C 14/02; F24C 14/00; A47J 27/04; C11D 11/00; C11D 7/26; B01D 53/86; B01D 53/96

(52) U.S. Cl. CPC F24C 14/02; F24C 14/005; A47J 27/04; F24C 15/2014; C11D 7/265; B01D 53/86; B01D 53/96; C11D 11/0041

(57) ABSTRACT

A combination oven using non-caustic detergent during a cleaning wash cycle, along with the addition of a catalyst regeneration cycle after a predefined number of cleaning wash cycles, can regenerate the catalyst to restore nearly full function of the catalyst and removes most occlusion of the pores of the catalyst that occurs during oven cooking and cleaning wash cycles. The catalyst regeneration cycle includes a rinse agent cycle followed by a high temperature dry out and burnout step.

### CROSS REFERENCE TO RELATED APPLICATION

This application claims the benefit of U.S. Provisional Patent Application No. 63/342,697, filed May 17, 2022, which is incorporated by reference herein in its entirety.

### BACKGROUND OF THE INVENTION

The present invention relates to ovens for the preparation of food, and in particular, to a combination oven providing separately controlled convection heating and steam generation heating within each cooking zone and catalytic treatment of cooking fumes.

Combination steam and convection ovens (“combi-ovens”) cook using combinations of convection and steam. In convection cooking, heated air is circulated rapidly through the cooking compartment to break up insulating layers of air around the food, thereby increasing the rate of heat transfer. Steam enhances the rate of heat transfer to the food as a result of the high specific heat of water compared to dry air and can also reduce water loss from the food. Combi-ovens are described, for example, in U.S. Pat. Nos. 7,307,244 and 6,188,045 assigned to the assignee of the present invention and hereby incorporated by reference.

Combi-ovens may have provisions for cleaning by introducing water into the cooking cavity together with a detergent. This water and detergent may be heated and circulated by the oven fan and heater as a high velocity, atomized mist. Commercial cooking ovens may employ cleaning cycles using water and detergent and various cycles of rinse water and steam to clean the oven interior at regular intervals.

Combi-ovens, when cooking food, also produce cooking fumes and odors that are typically handled by exhaust hoods providing power ventilation of fumes and odors out of the kitchen. In some circumstances, where an exhaust hood is impractical or undesirable (ventless ovens), it is known to treat such cooking fumes using catalytic converters which break down the components of the cooking fumes in a catalytic chemical process. In some situations, catalysts may also be used in combination with an exhaust hood.

Commercial cooking ovens may use catalysts in one or more exhaust streams in order to reduce the level of fumes and odors in the kitchen. However, a catalyst system cannot be used in the same oven as cleaning cycles because the caustic detergents used in the cleaning cycles is known to cause occlusion of the pores of the catalyst, which blocks the catalyst from being able to function properly.

### SUMMARY OF THE INVENTION

The present invention further improves over the prior art by providing combi-ovens or multi-cook ovens with both detergent cleaning systems and catalyst systems using catalyst regeneration cycles to restore catalyst function.

The present inventors have recognized that a combination of non-caustic detergent used in the cleaning cycle, along with the addition of a catalyst regeneration cycle after a predefined number of cleaning cooking and wash cycles, is able to regenerate the catalyst to restore nearly full function of the catalyst and removes most occlusion of the pores of the catalyst that occurs during repeated oven cooking and cleaning cycles.

In one embodiment of the present invention a combination oven comprises an insulated housing including a door configured to close to define an interior cooking cavity and an opening to provide access to the cooking cavity; a cooking cavity heater communicating with the cooking cavity to heat the cooking cavity according to a temperature signal; a steam generator for producing steam within the cooking cavity according to a steam production signal; a catalyst chamber for eliminating smoke and fumes within the cooking cavity; and a controller communicating with the cooking cavity heater, steam generator, and executing a program stored in memory during a cleaning mode to: (i) control the circulation of a detergent material through the catalyst chamber; (ii) control the circulation of a rinse agent through the catalyst chamber; (iii) control the operation of the cooking cavity heater according to the temperature signal.

It is thus a feature of at least one embodiment of the present invention to permit detergent cleaning systems to be used in combination with catalyst systems in the same oven by regenerating catalyst function when cleaning detergents diminish catalyst function.

The rinse agent may be an acetic acid solution.

It is thus a feature of at least one embodiment of the present invention to rinse the catalyst chamber during catalyst regeneration cycles in order to clear occlusions of pores in the catalyst caused by cleaning detergents used during repeated cleaning cycles.

The acetic acid solution may be in a tablet or liquid form.

It is thus a feature of at least one embodiment of the present invention to allow the user to easily fill the oven with a rinse chemical agent that runs through the same cleaning system as the detergent.

The acetic acid solution may be 5% to 10% acetic acid solution.

It is thus a feature of at least one embodiment of the present invention to remove organic deposits on the catalyst.

The detergent may be non-caustic detergent.

It is thus a feature of at least one embodiment of the present invention to utilize detergents that minimize deposit buildup due to repeated cooking cycles and thus causing occlusions to the catalyst.

A steam generator heater may be independent of the cooking cavity heater.

It is thus a feature of at least one embodiment of the present invention to provide high heat dry out of moisture and burnout of organic deposits on the catalyst during catalyst regeneration cycles in order to regenerate the catalyst.

A fan may be used for circulating air to the cooking cavity heater.

It is thus a feature of at least one embodiment of the present invention to assist with circulation of the cleaning detergent and rinse agent through the oven during the cleaning cycles and catalyst regeneration cycles, respectively.

The controller may execute a program stored in memory during a cooking mode and a cleaning mode to: control the operation of the cooking cavity heater according to a first temperature signal during the cooking mode and a second temperature signal during the cleaning mode; and control the operation of the steam generator according to a first steam production signal during the cooking mode and a second steam production signal during the cleaning mode

It is thus a feature of at least one embodiment of the present invention to operate separate cooking cycles, cleaning cycles, and catalyst regeneration cycles where heat and steam are implemented during each cycle but at different temperatures and levels of steam generation.

Controlling the operation of the cooking cavity heater during the cleaning mode may raise the temperature of the oven to a temperature of at least 500 degrees Fahrenheit for at least one hour.

It is thus a feature of at least one embodiment of the present invention to heat the oven to a high enough temperature that is higher than most cooking temperatures for dry out of rinse solution and burnout of organic deposits on the catalyst.

The third temperature signal may raise the temperature of the oven to a temperature that is greater than the oven temperature from the first and second temperature signals.

In an alternative embodiment of the present invention a method of operating a cleaning mode of a combination oven comprises providing an oven having an insulated housing including a door configured to close to define an interior cooking cavity and an opening to provide access to the cooking cavity, a cooking cavity heater communicating with the cooking cavity to heat the cooking cavity, a steam generator for producing steam within the cooking cavity according to a steam production signal, the steam generator having a water input jet and a steam generator heater independent of the cooking cavity heater, and a controller communicating with the cooking cavity heater and steam generator; circulating a detergent material through the catalyst chamber during at least one cleaning cycle; circulating a rinse agent through the catalyst chamber during a catalyst regeneration cycle; and operating the cooking cavity heater according to the temperature signal during a catalyst regeneration cycle.

It is thus a feature of at least one embodiment of the present invention to implement a rinse cycle and catalyst regeneration cycle following oven cleaning to restore full function of the catalyst in order to reduce the level of smoke and odor in the kitchen environment.

The step of operating the cooking cavity heater raises the temperature of the oven to a temperature of at least 500 degrees Fahrenheit. The step of operating the cooking cavity heater is for at least one hour.

It is thus a feature of at least one embodiment of the present invention to elicit dry out of the rinse agent and burn out of organic deposits.

The method may further include circulating a detergent material through the cooking cavity heater and steam generator. The method may further include circulating a detergent material through a steam generator heater independent of the cooking cavity heater. The method may further include circulating a detergent material through a fan for circulating air to the cooking cavity heater.

It is thus a feature of at least one embodiment of the present invention to permit cleaning in areas of the oven prone to grease and residue buildup and using the same circulation path for the rinse cycle.

These particular objects and advantages may apply to only some embodiments falling within the claims and thus do not define the scope of the invention.

### BRIEF DESCRIPTION OF THE DRAWINGS

FIG. 1 is a perspective view of a four-cavity oven according to one embodiment of the present invention showing an expanded detail of a shelf made of separate upper and lower plenums individually removable through the open door of the oven;

FIG. 2 is a cross-sectional view taken along line 2-2 of FIG. 1 showing the segregated internal air channels in the shelf such as may conduct different temperatures of air while maintaining thermal separation between the cavities by active insulation and other techniques;

FIG. 3 is a simplified block diagram of the air delivery system and water control valves used for steam generation and cleaning feedback control;

FIG. 4 is a fragmentary elevational schematic cross-section through multiple cavities of FIG. 1 showing the airflow from a fan and heater system into the cavities via the shelves dividing the cavities;

FIG. 5 is a planar schematic cross-section through one cavity of the oven of FIG. 1 showing the fan and steam-generating system together with a catalyst within a single airflow path drawing air into and out of the cooking cavity; and

FIG. 6 is a cleaning cycle chart showing a predefined number of cooking cycles and cleaning cycles followed by a catalyst regeneration cycle implemented by the oven controller.

### DETAILED DESCRIPTION OF THE PREFERRED EMBODIMENT

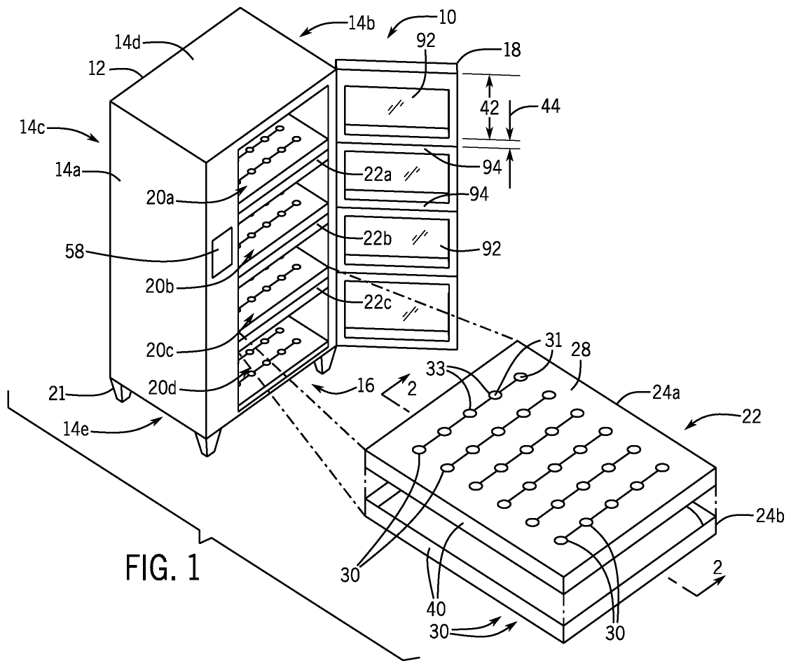

Referring now to FIG. 1, a multi-zone, combi-oven 10 may provide for a housing 12 having upstanding insulated left and right outer sidewalls 14a and 14b and an upstanding outer insulated rear wall 14c extending between and joining opposed, generally horizontal insulated outer upper walls 14d and 14e. The walls 14 enclose a volume 16 opening toward the front and which may be covered by hinged door 18 when the door 18 is in a closed position as is generally understood in the art. The housing 12 may be supported on one or more legs 21 extending downwardly from a bottom surface of the bottom wall 14e.

The cooking volume 16 may be divided into multiple cooking cavities 20a-20d. Although four cooking cavities are shown, the invention contemplates a range from 2 to 6 cooking cavities 20 in vertical, spaced separation. Each of the cooking cavities 20 is separated by a shelf 22a-c with shelf 22a separating cavities 20a and 20b, shelf 22b separating cavities 20b and 20c and shelf 22c separating cavities 20c and 20d.

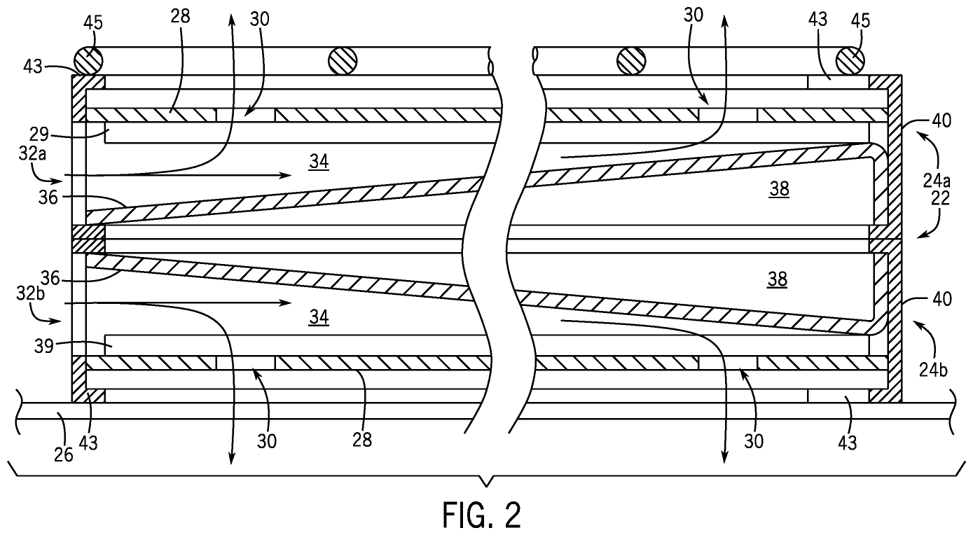

Referring also to FIG. 2, each shelf 22 may be made up of separate upper and lower generally rectangular plenum 24a and 24b fitting horizontally in the cooking volume 16 with plenum 24a facing an upper cavity 20 and plenum 24b facing a lower cavity 20. A single upper plenum 24a forms the bottom of the lowermost cavity 20d and a single lower plenum 24b forms the upper wall of the uppermost cavity 20a.

The outer surface of each plenum 24 provides a horizontally extending air distribution plate 28 having a set of airstream openings 30 distributed over its area to provide for substantially even airflow therethrough. In one embodiment, the airstream openings 30 in the air distribution plate 28 may provide a series of holes 31 joined by slots 33 extending in multiple rows from the left to the right side of the cavities 20 as described in, for example, U.S. Pat. No. 10,088,172 assigned to the assignee of the present invention and hereby incorporated by reference.

Generally, a width of the slots 33 will be less than 0.05 inches and preferably less than 0.1 inches to reduce pressure loss in the channel 34 that could result from high slot area. The holes 31 are much larger than the slots 33 and may be circular and may have a diameter ranging from 0.3 inches to 0.6 inches to provide airstreams that help shepherd the air from the slots 33 while also minimizing loss of air pressure. Slot lengths may vary between 1 to 2 inches and are preferably approximately 1.6 inches. The air distribution plate 28 is a thin sheet of metal, for example, stainless steel, with a thickness less than ⅛ inch and typically less than 1/16 inch, such as may be easily formed using laser cutting techniques.

Air enters through sidewalls of each of the plenums 24a and 24b at air inlets 32a and 32b, respectively, from corresponding outlets at the rear of each cavity. These air inlets 32 may be as little as one and a half inches tall and preferably less than one inch tall. From the air inlets 32a and 32b, the air then passes through a horizontally extending channel 34 defined by an inner surface of the air distribution plates 28 and inner surface of a focusing wall 36 opposite the air distribution plate 28 about the channel 34. The focusing wall 36 has a maximum separation from the air distribution plate 28 at the air inlet 32 and then curves inward toward the air distribution plate 28 as air conducted in the channel 34 escapes through the airstream openings 30 and less channel height is needed. This inward sloping of the focusing walls 36 for each of the plenums 24a and 24b together provides an additional insulation zone 38 between the barrier walls 36 of the upper and lower plenums 24a and 24b, respectively, minimizing shelf height but maximizing insulation value. The average separation of the barrier walls 36 may be approximately one inch varying from contact between the barrier walls to nearly 2 inches in separation. The invention contemplates an average separation of at least one-quarter inch and preferably at least one inch.

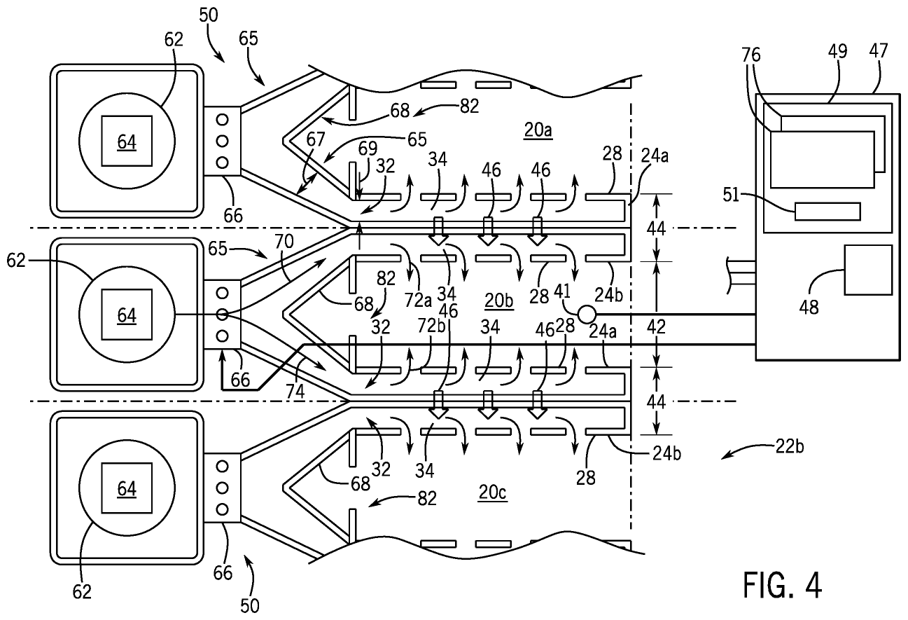

A peripheral wall 40 of each plenum 24 surrounds the air distribution plate 28 and the barrier wall 36 to corral air within the channel 34 in all directions except through the inlets 32 and the airstream openings 30. Peripheral wall 40 also provides inwardly horizontally extending tabs 43 which may support a wire rack 45 at a separation of approximately ¼ inch and at least ⅛ inch above the upper extent of the air distribution plate 28 of the upper plenum 24a. In one embodiment the wire rack 45 may be supported by more than one inch above the air distribution plate 28 and desirably more than 1.5 inches above the air distribution plate either through the use of a special wire rack 45 or extender tabs 43 (not shown). In this way, a cooking sheet or pan set on top of the shelf 22 rests on the wire rack 45 and does not block the airstream openings 30. In a preferred embodiment, a separation 44 (shown in FIGS. 1 and 4) between the uppermost extent of the airstream openings 30 of the air distribution plate 28 of the upper plenum 24a and the lowermost extent of the airstream openings 30 of the air distribution plate 28 of the lower plenum 24b will be less than four inches, preferably less than three inches and desirably less than two inches providing an extremely compact shelf maximizing cavity space and minimizing total height. The cavities 20 (shown in FIGS. 1 and 4) will have a nominal height 42 between four and nine inches and preferably five inches or more defined by the distance between air distribution plates 28 bounding the upper and lower extent of the cavity 20. In one nonlimiting example, each cavity may add a height of about seven inches to the oven so that three cavities may have a height of no more than 23 inches or at least no more than 25 inches, and four cavities may have a nominal height of 30 inches and no more than 35 inches.

Generally, the shelves 22 may be constructed entirely of stainless steel for durability and ease of cleaning, and although the invention contemplates that thin insulating materials may also be incorporated into the shelves 22 in some embodiments, the invention contemplates that non-metallic shelf construction materials are not required. The barrier walls 36 may be held within each plenum 24 with a “floating mounting” allowing sliding of the barrier walls 36 with respect to the other structures of the plenums 24, for example, by creating a sliding fit between these components augmented by a natural flexure of the metal of the barrier walls 36 providing a light pressure between the barrier walls 36 and the ribs 29 and inwardly extending lips of the peripheral walls 40.

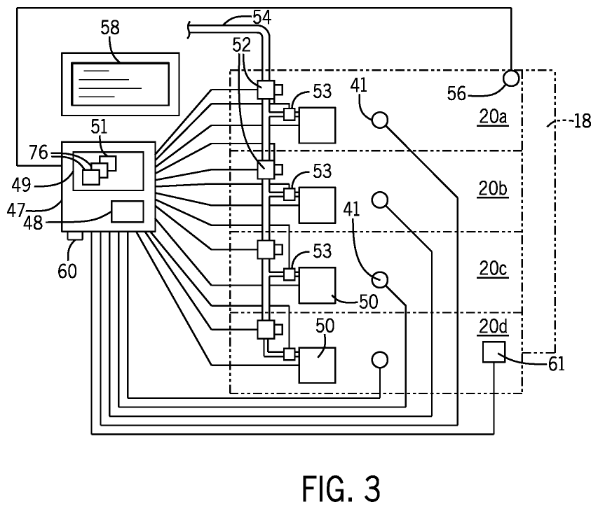

Referring now to FIG. 3, each of the cavities 20 may be associated with a temperature sensor 41 communicating with a controller 47, for example, being a microcontroller having one or more processors 48 executing programs and communicating with an associated memory 49, holding an operating program 51 and various recipe schedules 76. The temperature sensors 41 may be thermistors, resistive temperature sensors, or the like.

Each cavity 20 may also be associated with an airflow system 50 comprising a heater system, fan motor, and variable speed motor controller so that the controller 47 may independently control the airflow circulating through each cavity 20 through a continuous range and may control the temperature of that air through a continuous range of temperatures. The heater system may be, for example, an electric resistance heater such as a “cal” rod controlled by a solid-state relay or may be a heat exchanger of an electrically controllable gas burner system.

Optionally, each cavity 20 may have an electrically controllable wash water valve 52 communicating with a common water supply 54 so that water for cleaning may be introduced into the cavity by a signal to the controllable wash water valve 52 from the controller 47. Additional steam control valve 53 may be operated to allow water to be introduced to the heating units of the airflow system 50 as will be discussed below to allow independent control of moisture according to a cooking schedule. Mechanisms for the introduction of controlled moisture into an oven cavity 20 suitable for use with the present invention are described, for example, in U.S. Pat. Nos. 9,375,021; 7,307,244; 7,282,674; and 6,188,045 assigned to the assignee of the present application and hereby incorporated by reference.

The controller 47 may also receive a signal from a door switch 56 (such as a limit switch or proximity switch) and may provide for input and output to an oven user through a user interface 58 such as a touch screen, graphic display, membrane switch or the like such as are well known in the art. A data connector 60 may communicate with the controller 47 to allow for readily uploading cooking schedules 76 over the Internet or by transfer from a portable storage device or the like.

One or more of the cavities 20 may also include a smoker 61, for example, providing a compartment that may hold woodchips or the like to be heated by an electric element controlled by the controller 47 through corresponding solid-state relays. The construction of a smoker 61 suitable for the present invention is described, for example, in U.S. Pat. Nos. 7,755,005; 7,317,173; and 7,157,668 assigned to the assignee of the present invention and hereby incorporated by reference.

Referring now to FIG. 4, the airflow system 50 of each cavity 20 (indicated generally by separating dotted lines) may include a separate fan 62 independently controlled by a variable speed motor and motor drive 64. The fan 62 may be, for example, a squirrel cage fan and the motor a DC synchronous motor driven by a solid-state motor controller of a type known in the art. The use of separate fans 62 permits full segregation of the airflows within each cavity 20. The use of a separate motor and motor drive 64 allows independent airspeed control of the air in each cavity 20.

The airflow system 50 may also include a heater 66 and the air from each fan 62 may pass through a heater 66 to be received by a bifurcated manifold 68 which separates the heated airstream into an upper airstream 70 and lower airstream 74. The upper airstream 70 passes into the channel 34 (shown in FIG. 2) of a lower plenum 24b of an upper shelf 22 defining an upper wall of the cavity 20 and then exits from the channel 34 as a set of downwardly directed airstreams 72a from each of the airstream openings 30 (shown in FIG. 2) distributed over the lower area of the plenum 24b. The lower airstream 74 passes into the upper channel 34 of upper plenum 24a of a lower shelf 22 defining a lower wall of the cavity 20 to exit from the channel 34 as a set of upwardly directed airstreams 72b from each of the airstream openings 30 (shown in FIG. 2) distributed over the upper area of the plenum 24a.

The bifurcated manifold 68 may be designed to provide substantially greater airflow in the upper airstream 70 than the airflow of the lower airstream 74, for example, by constrictions or orientation of the branches of the bifurcated manifold 68 with respect to the natural cyclic flow of the fan. In one example, the air may be split so that 53 to 60 percent of the heated air is allocated to the lower shelf sending air upward, and 40 to 57 percent of the heated air is allocated to the upper plenum pulling downward as described in U.S. patent application Ser. No. 15/016,093 cited above.

This arrangement of fans, airflow system 50 and bifurcated manifold 68 is duplicated for each cavity 20. In the uppermost cavity 20a only a single lower plenum 24b is provided at the top of that cavity 20a and in the lowermost cavity 20d only a single upper plenum 24a is provided, each being effectively one half of shelf 22.

A multizone oven of this general design is discussed in U.S. Pat. Nos. 10,684,022; 10,986,843; and U.S. publication 2021/0247075 assigned to the assignee of the present application and hereby incorporated by reference.

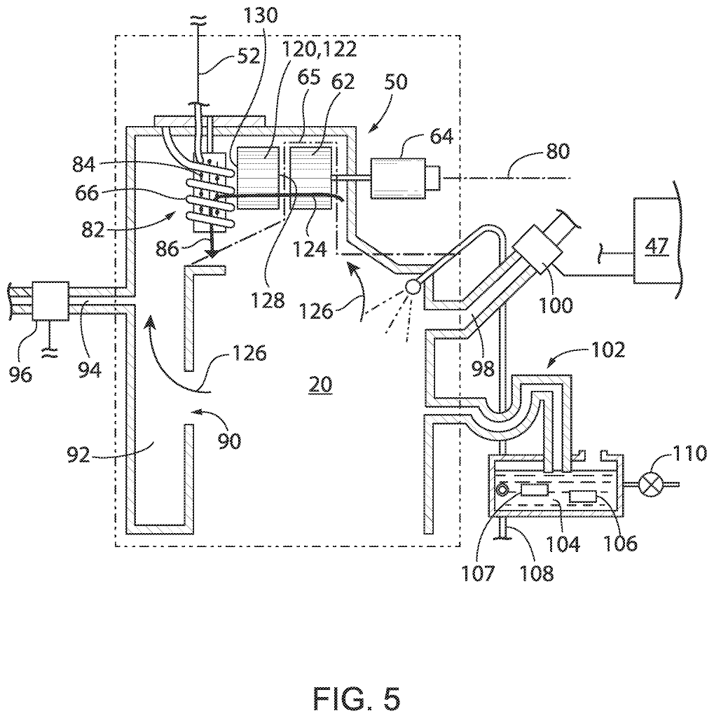

Referring now to FIG. 5, in one embodiment, the fan 62 may be a centrifugal fan having a squirrel cage impeller mounted for rotation about a horizontal axis 80 extending from the right to left wall of the oven 10 with the fan 62 centered with respect to the volume of the cavity 20.

A steam generator 82, also positioned rearward from each cavity 20 and leftward from the fan 62 (for example), provides a water injector 84 providing a conduit and nozzle directing a stream of water or water droplets onto a diverter bracket 86. The diverter bracket 86 may be mounted to surround steam heater tubes 88 for steam generation of dispersed water droplets. The steam generator 82 may be as described in U.S. application 63/212,943 assigned to the assignee of the present application and hereby incorporated by reference.

The water injector 84 may disperse freshwater onto the diverter bracket 86 to break up the water and emit a fine spray of water that is further heated by a helical heater tube of heater 66 surrounding the diverter bracket 86. Water to the water injector 84 may be controlled by an electronically controlled wash water valve 52. In this way, the convection fan speed-controlled motor 64, heater 66, and steam heater tubes 88 are independently controlled to provide separate control of a heating of the oven cavity 20 and steam generation of the oven cavity 20.

A catalyst chamber 120, also positioned rearward from each cavity 20 and leftward from the fan 62 and at the fan 62 inlet (for example), provides catalyst units 122 positioned within the catalyst chamber 120 and within the airflow path 124 of return air 126 from the fan 62 so that return air 126 passes into an inlet aperture 128 and through the catalyst units 122 and out an exit aperture 130, to eliminate smoke in the airstream by reducing it to carbon dioxide and water.

Preferably, the catalyst units 122 are a metallic substrate coated with a catalytic material known in the art. Preferred catalytic converter materials are precious metal-based materials, such as palladium or platinum/palladium-based materials, e.g., manufactured by Catalytic Combustion Corporation. The substrate layers are processed so that they form a series of channels generally parallel with the flow of the return air 126. The number of channels per unit of face area can range from 40 to 350 channels/per square inch depending upon the desired volume of return air 126 flowing through the catalyst chamber 120, the amount of cross sectional area of the catalyst units 122, and the amount of resistance to flow caused by any pressure differences. The necessary flow of return air 126 may be empirically determined but will generally be such as to provide a treatment of only a portion of the air within the cooking volume 16 every minute. As the return air 126 passes through the catalyst units 122, cooking fumes including smoke and vapor (i.e., volatile organic compounds) in the circulating air stream are more completely oxidized to CO₂ and H₂O to prevent smoke from being recirculated into the cooking volume 16 or exhausted therefrom when the door 18 is open or through minor exhaust passing through the drain 108. The catalytic conversion process is generally exothermic which will also provide some heating of the catalyst.

Catalysts suitable for use with the present invention are described, for example, in U.S. Pat. No. 9,683,747 assigned to the assignee of the present application and hereby incorporated by reference.

Referring still to FIG. 5, air from the fan 62 as heated by the heater 66 may enter into the cavity 20 to heat contained food and then be drawn through a side vent 90 into a return duct 92 to again pass by the heater 66. The size of the side vent 90 is such as to provide a slight constriction producing a low pressure in the return duct which may communicate with a fresh air conduit 94, either directly or optionally controlled by valve 96, providing air inlet from outside of the oven. Valve 96 may be controlled by the controller 47.

Likewise, the cavity 20 will be at slightly higher pressure because of the size of the side vent 90 and may communicate with an exhaust conduit 98 controlled by valve 100 through controller 47 providing an exhaust of air and steam from the cavity 20 to the outside air as will be discussed below.

As noted above, wash water can be introduced into the cavity 20, for example, through a spray nozzle in the cavity 20 or in the bifurcated manifold 68 or both. A system of drains 102 allows excess water to be drained into a holding reservoir 104 into which a detergent material 106 and rinse agent 107 may be placed for cleaning. This reservoir 104 may provide water through a pump (not shown) to the wash water valve 52 for recycling cleaning water and may provide for a drain 108 and freshwater make up valve 110 leading to a freshwater supply as is generally understood in the art.

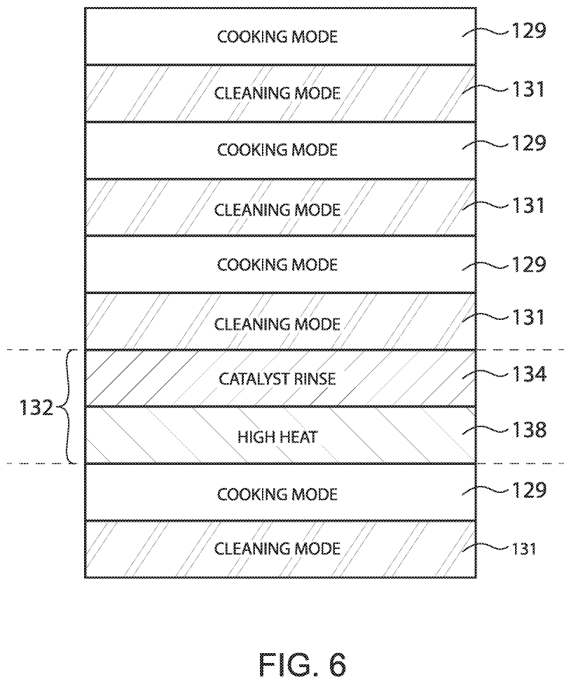

Referring now to FIG. 6, within each cavity 20, a program 51 in the memory 49 of the controller 47 may provide for independent operation of the fan 62, heater 66, and steam generator 82 providing control of the temperature of the cooking cavities 20 during different cooking modes or cycles 129. The program 51 in the memory 49 of the controller 47 may also provide for independent operation of the fan 62, heater 66, and steam generator 82 during a cleaning and catalyst regeneration operation described below and according to the cleaning schedule of the program 51 in the memory 49. For example, the cooking cycle 129 may be followed by a cleaning cycle 131 according to a cleaning schedule of the program 51 in the memory 49.

During the cleaning cycle 131, the same flow path 124 as the return air 126 is used by the cleaning liquid or detergent material 106. The detergent material 106 flows along the flow path 124 including flowing through the catalyst units 122. The detergent material 106 is desirably a non-caustic detergent but may be a caustic detergent. The cleaning cycle 131 (and cooking cycle 129) may be repeated a desired number of times before the catalyst regeneration cycle 132 is initiated by the cleaning schedule of the program 51 in the memory 49.

After a predefined number of cooking cycles 129 and/or cleaning cycles 131, the catalyst units 122 are desirably regenerated to restore function of the catalyst. The catalyst regeneration cycle 132 is initiated by the cleaning schedule of the program 51 in the memory 49.

The catalyst regeneration cycle 132 includes, first, a catalyst rinse cycle 134 consisting of a recycling of a rinse agent 107 through the flow path 124. As noted above, the rinse agent 107 follows the same path as wash water which is introduced into the cavity 20, for example, through a spray nozzle in the cavity 20 or in the bifurcated manifold 68 or both.

During the catalyst rinse cycle 134, the same flow path 124 as the return air 126 and detergent material 106 is used by the rinse agent 107. The rinse agent 107 flows along the flow path 124 including flowing through the catalyst units 122. The rinse agent 107 may be, for example, a tablet or liquid based acetic acid solution of 5% to 10% acetic acid.

Following the catalyst rinse cycle 134, a high heat cycle 138 is implemented by the heater 66 and/or steam heater tubes 88 to drive off moisture and eliminate any potential organic deposits remaining on the catalyst units 122. The high heat cycle 138 may last at least one hour and may be approximately one to two hours at a high temperature of at least 500 degrees Fahrenheit and at least 525 degrees Fahrenheit and at least 550 degrees Fahrenheit.

It is understood that the high heat cycle 138 is generally at a temperature that is higher than the cooking cycles 129 and cleaning cycles 131 where the temperature of the cooking cycles 129 and/or cleaning cycles 131 is less than 500 degrees Fahrenheit and less than 525 degrees Fahrenheit and less than 550 degrees Fahrenheit. Following the high heat cycle 138, the cooking cycles 129 and/or cleaning cycles 131 may resume and the schedules of cooking and cleaning repeated.

It is understood that the combination of non-caustic detergent material 106 used during the cleaning cycle 131, along with the addition of the catalyst regeneration cycle 132 after a predefined number of cleaning cycles 131, can regenerate the catalyst units 122 to restore nearly full function by removing the organic deposits that are built up in the catalyst units 122. The addition of the rinse agent 107 during the rinse cycle 134 and the high temperatures reached during the high heat cycle 138 permit the catalyst units 122 to be used with a non-caustic detergent cleaning system to minimize occlusion of the catalyst pores thus allowing both detergent cleaning cycles 131 and catalyst units 122 to be used within the same oven 10, and within the same cooking cavities 20 and their respective airflow systems 50.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

We claim:

1. A combination oven comprising:
an insulated housing including a door configured to close to define an interior cooking cavity and an opening to provide access to the cooking cavity;
a cooking cavity heater communicating with the cooking cavity to heat the cooking cavity according to a temperature signal;
a steam generator for producing steam within the cooking cavity according to a steam production signal;
a temperature sensor for sampling a temperature of the cooking cavity to provide a temperature signal;
a catalyst chamber for eliminating smoke and fumes within the cooking cavity; and
a controller communicating with the cooking cavity heater, steam generator, and executing a program stored in memory during a cleaning mode to:
(i) control the circulation of a detergent material through the catalyst chamber;
(ii) control the circulation of a rinse agent through the catalyst chamber;
(iii) control the operation of the cooking cavity heater according to the temperature signal.

2. The combination oven of claim 1 wherein the rinse agent is an acetic acid solution.

3. The combination oven of claim 2 wherein the acetic acid solution is in a tablet or liquid form.

4. The combination oven of claim 3 wherein the acetic acid solution is 5% to 10% acetic acid solution.

5. The combination oven of claim 1 wherein the detergent is a non-caustic detergent.

6. The combination oven of claim 1 further comprising a steam generator heater independent of the cooking cavity heater.

7. The combination oven of claim 1 further comprising a fan for circulating air to the cooking cavity heater.

8. The combination oven of claim 1 wherein the controller executes a program stored in memory during a cooking mode, a cleaning mode, and a catalyst regeneration mode to:
control the operation of the cooking cavity heater according to a first temperature signal during the cooking mode, a second temperature signal during the cleaning mode, and a third temperature signal during the catalyst regeneration mode; and
control the operation of the steam generator according to a first steam production signal during the cooking mode, a second steam production signal during the cleaning mode, and a third steam production signal during the catalyst regeneration mode.

9. The combination oven of claim 8 wherein the third temperature signal raises the temperature of the oven to a temperature of at least 500 degrees Fahrenheit for at least one hour.

10. The combination oven of claim 8 wherein the third temperature signal raises the temperature of the oven to a temperature that is greater than the oven temperature from the first and second temperature signals.

11. A method of operating a cleaning and catalyst regeneration mode of a combination oven comprising:
providing an oven having an insulated housing including a door configured to close to define an interior cooking cavity and an opening to provide access to the cooking cavity, a cooking cavity heater communicating with the cooking cavity to heat the cooking cavity, a steam generator for producing steam within the cooking cavity according to a steam production signal; a temperature sensor for sampling a temperature of the cooking cavity to provide a temperature signal; a catalyst chamber for eliminating smoke within the cooking cavity, and a controller communicating with the cooking cavity heater and steam generator;
circulating a detergent material through the catalyst chamber during at least one cleaning cycle;
circulating a rinse agent through the catalyst chamber during a catalyst regeneration cycle; and
operating the cooking cavity heater according to the temperature signal during a catalyst regeneration cycle.

12. The method of claim 11 wherein the step of operating the cooking cavity heater raises the temperature of the oven to a temperature of at least 500 degrees Fahrenheit.

13. The method of claim 12 wherein the step of operating the cooking cavity heater is for at least one hour.

14. The method of claim 11 further comprising circulating a detergent material through the cooking cavity heater and steam generator.

15. The method of claim 14 further comprising circulating a detergent material through a steam generator heater independent of the cooking cavity heater.

16. The method of claim 15 further comprising circulating a detergent material through a fan for circulating air to the cooking cavity heater.

17. The method of claim 11 wherein the rinse agent is an acetic acid solution.

18. The method of claim 17 wherein the acetic acid solution is in a tablet of liquid form.

19. The method of claim 18 wherein the acetic acid solution is 5% to 10% acetic acid solution.
